(19) United States
(12) Patent Application Publication
(10) Pub. No.: US 2026/0361173 A1
(43) Pub. Date: Nov. 12, 2026

(54) METHOD TO PRODUCE AN INSULATED METAL ELEMENT AND INSULATED METAL ELEMENT

(71) Applicant: NV BEKAERT SA, Zwevegem (BE)

(72) Inventors: Peter PERSOONE, DEINZE (BE); Kris ROOMS, Zwevegem (BE); Maarten VIERSTRAETE, Heule (BE); Philippe VAN RANST, Kortrijk (BE)

(73) Assignee: NV BEKAERT SA, Zwevegem (BE)

(21) Appl. No.: 19/130,308

(22) PCT Filed: Dec. 1, 2023
(86) PCT No.: PCT/EP2023/083899

§ 371 Date: May 15, 2025

(30) Foreign Application Priority Data
Dec. 5, 2022 (EP) 22211403.5

(51) Int. Cl. H02K 3/40; H01B 1/02; H01B 3/42; H01B 13/00; H01B 13/06; H02K 3/30; H02K 15/122

(52) U.S. Cl. CPC H02K 3/40; H01B 3/427; H01B 13/0016; H01B 13/06; H02K 3/30; H02K 15/122; H01B 1/02

(57) ABSTRACT

A new method to produce an insulated metal element having stable electrical properties comprises the steps: a) Providing a metal element b) Providing a thermoplastic polymer c) Cleaning the surface of said metal element d) Heating said metal element at a temperature between Tm+20 °C and Tm+60 °C, Tm being the melting temperature of said thermoplastic polymer e) Applying said thermoplastic polymer on the surface of said metal element f) Cooling the coated metal element to a temperature higher than [(Tm+Tg)/2−40 °C] and lower than [(Tm+Tg)/2+40 °C], with Tm the melting temperature of said thermoplastic polymer and Tg the glass transition temperature of said thermoplastic polymer g) Stopping the cooling for 2 s to less than 10 s h) Quenching the coated metal element to a temperature below 50 °C.

### TECHNICAL FIELD

The invention relates to a method to produce an insulated metal element having stable electrical properties, to an insulated metal element having stable electrical properties obtained with the said method, and the use of said insulated metal element as a magnet wire.

### BACKGROUND ART

Insulated metal elements are used in several applications where a metal conductor needs to be insulated. For example it can design a cross-linked polyethylene (XLPE) insulated conductor for the medium-voltage lines and a XLPE insulated conductor or a polyvinyl chloride (PVC) insulated conductor for the low-voltage line.

Insulated metal elements are also used in the stator of electric motors, for both synchronous (permanent magnet) and asynchronous (induction) motors. New challenges for automotive electric motors include:
higher motor speed;
compact design and maximized power/unit;
high reliability (short circuits, fire hazard);
large production runs;
high assembly-speed;
automated assembly;
cost reduction.

With the increase of battery voltage above 500V to increase the electric vehicle autonomy and decrease the charging time, insulated metal elements used as magnet wires in electrical motors need to be resistant at high voltage against partial discharges and hence exhibit a high partial discharge inception voltage (PDIV).

Moreover, insulated metal elements used as magnet wires in electrical motors need to exhibit stable electrical properties with time. Stable electrical properties depend mainly on the type of insulation layer, its resistance to temperature variation and adhesion to the metal element.

### Partial Discharge Inception Voltage

When an insulation layer, acting as a barrier, has a defect such as an internal void, the defect will display localized ionization when exposed to high voltage. This ionization starts at one voltage and stops at a lower voltage. These are called the inception and extinction voltages. As high voltage is applied to the barrier, voltage will also build up across the void. When the inception voltage is reached, the void ionizes, shorting itself out. When the voltage across the void drops below the extinction voltage, ionization ceases. This action redistributes charge within the barrier and is known as partial discharge. If the barrier voltage continues to rise, another partial discharge cycle begins. If the barrier voltage is alternative current (AC) and is large enough, partial discharge cycles will repeat many times during the positive and negative peaks. If the ionization begins and continues, it can damage the barrier, leading to failure. If the discharge does not occur, the barrier receives no damage. The inception voltage of the individual voids tends to be constant. Therefore, the total charge redistributed within the barrier is a very good indicator of the number of the voids and their likelihood of becoming a failure. Setting a very low limit on the allowable current caused by partial discharges in testing gives a very high degree of confidence that high voltage failure will not occur.

Studies have shown that there is a relationship between the partial discharge inception voltage, V, and both the insulation layer thickness, t, and the relative permittivity εr of the insulator (Dakin formula):

V=163(t/εᵣ)^{0.46}

Current ways to produce insulated metal elements resistant against PDIV comprise the application of an enamel layer on a copper wire. Enamel coatings are used in combination with paper liners in the stator. Paper wrapped windings increase insulation, but much space is lost because paper layers can be up to 500 μm thick.

U.S. Pat. No. 4,471,022A discloses a water-soluble polyimide, a coated wire and the method of coating. The insulation layer consists of poly imide (PI), at least 6 layers are deposited with long curing time for each layer.

U.S. Pat. No. 9,324,476B2 discloses an alternative insulated winding wire comprising at least two layers, the first one being an enamel polyamide-imide (PAI) layer, the second being polyether ether ketone (PEEK) or polyaryl-ether-ketone (PAEK).

U.S. Pat. No. 9,224,523B2 discloses an inverter surge-resistant insulated wire, also consisting of an enamel layer and extruded thermoplastic.

Increasing the thickness of an enamel (polyimide or polyamide-imide) layer increases the risk of defects and increases the cost of production.

The cost of increasing the insulating layer could be decreased by using powder deposition or extrusion of thermoplastic polymers. However, due to the poor adhesion between thermoplastic polymers and the metal element, a primer or bonding layer is usually necessary according to prior art.

Solutions to improve adhesion of extruded thermoplastic directly on a metal element, without the need for a primer or a bonding layer are disclosed in US 2019/0131037A1 and WO21041200A1.

US 2019/0131037A1 describes an insulated electric conductor obtainable by a method in which the electric conductor is placed under a protective gas atmosphere and is bombarded with ions of the protective gas in a gas plasma in order to remove an oxide layer formed on a surface of the electric conductor and/or to increase the surface energy of the conductor. The insulating coating layer either comprises at least one insulating layer made of thermoplastic material, or the insulating layer and a plastic-containing intermediate layer.

WO21041200A1 discloses an insulated electrical conductor comprising an electrical conductor comprising an oxide layer on at least part of a surface of the electrical conductor, and an insulating coating on at least a portion of the oxide layer. Good adhesion between the electrical conductor and the insulating coating is obtained by heat-treating the coated electrical conductor.

JPH02250206A discloses insulated electric wires having a PEEK insulating layer with crystallinity lower than 10% such that flexibility is obtained for winding, further subjected to a heat treatment to set the degree of crystallization of PEEK between 15 and 40% for improved hardness and chemical resistance.

U.S. Pat. No. 9,691,521B2 discloses a conductor having a thermosetting resin layer and a plurality of thermoplastic layers, wherein the second thermoplastic layer has a relative crystallinity higher than the first thermoplastic layer, and the first thermoplastic layer has a relative crystallinity in the range of 20% to 50%.

US2018/005724A1 discloses a conductor wrapped in a PEEK tape layer having a crystallinity of at least 25%.

U.S. Pat. No. 5,358,786A discloses an insulated wire comprising a conductor, an inner insulation layer 0.1-1 mm comprising a halogen-free polymer, an intermediate insulation layer 0.001 mm to 0.5 mm having a melting point<155 °C, and an outer insulation layer 0.05 mm to 1 mm having a melting point>155 °C.

### DISCLOSURE OF INVENTION

The present disclosure provides a new method to produce an insulated metal element having stable electrical properties in use. The new method does not require protective atmosphere such as in US 2019/0131037 and does not require a heat treatment step after cooling such as in US2020/047379. The higher production speed obtainable with the new method allow significant cost reduction in comparison with other existing methods. The invention solves the outcomes of the prior art, by providing an alternative insulated element, and the method to produce said insulated element.

It is a first object of the invention to provide a method to produce an insulated metal element having stable electrical properties. The method comprises the steps:
a) Providing a metal element
b) Providing a thermoplastic polymer
c) Cleaning the surface of said metal element
d) Heating said metal element at a temperature between Tm+20 °C and Tm+60 °C, Tm being the melting temperature of said thermoplastic polymer
e) Applying said thermoplastic polymer on the surface of said metal element
f) Cooling the coated metal element to a temperature higher than [(Tm+Tg)/2−40 °C] and lower than [(Tm+Tg)/2+40 °C], with Tm the melting temperature of said thermoplastic polymer and Tg the glass transition temperature of said thermoplastic polymer
g) Stopping the cooling for 2s to less than 10s
h) Quenching the coated metal element to a temperature below 50 °C.

Each step with preferred embodiments is described hereunder.

### Providing a Metal Element

The metal element is preferably elongated and can have a round or oval or profiled cross section.

In an embodiment the metal element has a squared or rectangular cross-section.

The metal element consists of pure metal or it can be a metallic alloy.

For instance, the metal element can be made of copper or copper-alloy.

Or the metal element can be made of aluminium or aluminium alloy.

Or the metal element can be made of iron or steel.

The metal element can also comprise different metals. For instance, a steel substrate can be coated with copper or a copper alloy. Another example is a steel substrate coated with aluminium or an aluminium alloy. Yet another example is a steel substrate coated with zinc or a zinc alloy.

The metal element can be a wire, a rod, or a tube.

### Providing a Thermoplastic Polymer

The polymer coating is preferably a thermoplastic, i.e. a substance that becomes plastic on heating and hardens on cooling, and is able to repeat these processes.

In one embodiment the polymer is selected in the family of poly(aryl ether ketone) (PAEK), for instance poly(ether ether ketone) (PEEK), or poly(ether ketone) (PEK), or poly(ether ketone ketone) (PEKK).

Preferably the polymer consists of PEEK.

The polymer coating layer can be applied by any technique known in the art, for example by extrusion or powder coating. Preferably, the coating layer is an extruded coating layer, as can be identified by observing the polymer chain orientation in the coating layer.

The polymer coating layer has preferably a thickness in the range 20 μm to 500 μm, for example between 30 μm and 400 μm or between 40 μm and 300 μm.

### Cleaning the Surface of Said Metal Element

The metal element has preferably a degreased surface.

Surface preparation is done by electrolytic cleaning, assisted chemical treatment (e.g. ultrasonic cleaning), plasma, laser ablation, or any combination thereof.

Heating Said Metal Element at a Temperature Between Tm+20 °C and Tm+60 °C, Tm being the Melting Temperature of Said Thermoplastic Polymer

Heating can be done by means of induction, resistive heating, gas oven, plasma, or any combination thereof.

As an example, when the melting temperature Tm of said thermoplastic polymer is 340 °C said metal element is heated at a temperature between 360 °C and 400 °C.

### Applying Said Thermoplastic Polymer on the Surface of Said Metal Element

The polymer coating is applied on the hot metal element by means of extrusion or powder coating.

Cooling the Coated Metal Element to a Temperature Higher than [(Tm+Tg)/2−40 °C] and Lower than [(Tm+Tg)/2+40 °C], with Tm the Melting Temperature of Said Thermoplastic Polymer and Tg the Glass Transition Temperature of Said Thermoplastic Polymer

Controlled cooling can be obtained by means of spraying a gas, e.g. N2 or compressed air on the surface of the coated metal element. Preferably, controlled cooling is done by immersion in water or by spraying water on the surface of the coated metal element. Other controlled cooling techniques mixing gas and water may also be used.

The duration and intensity of the cooling should be adjusted such that the surface of the coated metal element reaches a temperature higher than [(Tm+Tg)/2−40 °C] and lower than [(Tm+Tg)/2+40 °C]. No reheating above (Tm+Tg)/2+40 °C should occur after the first cooling step.

Stopping the Cooling for 2s to Less than 10s

To keep the surface of the coated metal element between [(Tm+Tg)/2−40 °C] and [(Tm+Tg)/2+40 °C] for 2s to less than 10s at the end of the first cooling step, a temperature holding zone may be used. Said temperature holding zone may comprise insulation elements and heating elements or hot air.

The temperature holding time between 2s and 10s determines the crystallinity rate, ensures good adhesion and stable electrical properties of the insulated metal element. In particular, holding times lower than 2s cause low crystallinity, and bad adhesion of the coating.

### Quenching the Coated Metal Element to a Temperature Below 50 °C.

As for the first cooling step, the final cooling step, or quenching, can be obtained by means of spraying a gas, e.g. N2 or compressed air on the surface of the coated metal element. Preferably, quenching is done by immersion in water or by spraying water on the surface of the coated metal element. Other controlled cooling techniques mixing gas and water may also be used.

In a preferred embodiment, above described steps c) to h) are executed in a production line wherewith said metal element is running at a linear velocity higher than 40m/min, e.g. 50m/min, e.g. 100m/min. The temperature range and temperature holding time at the end of the first cooling step are independent from the linear velocity of said metal element.

It is a second object of the invention to provide an insulated metal element having stable electrical properties, said insulated metal element comprises a metal element and a polymer coating, said polymer coating is in semi crystalline state, the rate of crystallinity is between 20% and 40%.

A metal element is coated with a thermoplastic polymer coating. There is no intermediate layer between the polymer and the metal element and the polymer coating is in semi-crystalline state.

Conductors from prior art always contain an adhesion layer between the metal element and the polymer coating because there is usually no adhesion between polymer and metal.

The method to produce the insulated element of the invention, which is described above, allows the suppression of an intermediate or bonding layer. The insulated element of the present invention therefore only contains a core metal element, the conductor and a polymer coating.

The adhesion between the polymer coating and the metal element is obtained by the control of the process parameters, in particular the speed of polymer deposition by e.g. extrusion, and the control of the cooling. The controlled cooling leads to a polymer coating with a desired range of crystallinity, which is characteristic for the present invention. The rate of crystallinity is between 10% and 40%, more preferably between 15% and 35%, even more preferably between 20% and 35%.

The metal element having a polymer coating of the invention has a partial discharge inception voltage at 20 °C above 800 Vrms, preferably above 900 Vrms, more preferably above 1000 Vrms.

The polymer coating is applied on the hot metal element by means of extrusion or powder coating.

The insulated metal element of the invention, obtained with the described method, is resistant at high voltage against partial discharges, has stable electrical properties in use, and is easier and cheaper to produce than insulated metal elements of the prior art.

A preferred use for an insulated metal element having stable electrical properties according to the invention is as hairpin wire for rotating or static parts of an electric motor. In that particular case said insulated metal element comprises Cu or a Cu-alloy as metal element and PEEK or a thermoplastic polymer from the family of PAEK.

### BRIEF DESCRIPTION OF FIGURES IN THE DRAWINGS

FIG. 1. Is a schematic cooling curve

FIG. 2. Is a plot of PEEK crystallinity as a function of the temperature holding time

### MODE(S) FOR CARRYING OUT THE INVENTION

Different insulated metal elements were produced according to the disclosed method:
a) rectangular shaped copper with section dimensions 3.7 mm×2 mm and >0.3 mm corner radius were provided as metal element on a carrier
b) PEEK was provided as thermoplastic polymer. The commercial PEEK was obtained from e.g. Solvay or Victrex. Both melting temperature Tm and glass transition temperature Tg were measured by DSC and were found to be 340 °C and 150 °C, respectively.
c) The rectangular shaped copper wire was unwound from the carrier at a linear velocity of 40m/min, cleaned and heated in line by means of plasma.
d) The surface temperature of the rectangular shaped copper wire at the exit of the heating device was measured by infra red camera and was set to 380 °C, which is Tm+40 °C.
e) PEEK was applied under ambient conditions, i.e. without protective atmosphere by means of extrusion on the surface of the copper wire.
f) The PEEK-coated copper wire was then cooled in water to 250 °C, which is a temperature higher than [(Tm+Tg)/2−40 °C] and lower than [(Tm+Tg)/2+40 °C], with Tm=340 °C, the melting temperature of PEEK and Tg=150 °C, the glass transition temperature of PEEK.
g) The cooling length in water was adjusted such that the coated metal element reached the desired temperature of 250 °C. The cooling was stopped and to avoid further cooling, hot air at 250 °C was blown to keep the temperature constant for a time selected between 2s to 10s. At the line velocity of 40m/min, the air blowing installation varied between 1.35m and 6.7m. At higher line velocity, e.g. 120m/min, the air blowing installation would be between 3.3m and 16.7m long. For short holding times, however, hot air blowing is not needed.
h) At the exit of the stop cooling length, the coated metal element was quenched in cold water to a temperature below 50 °C.

The cooled insulated metal element was finally wound on a carrier at a take up unit.

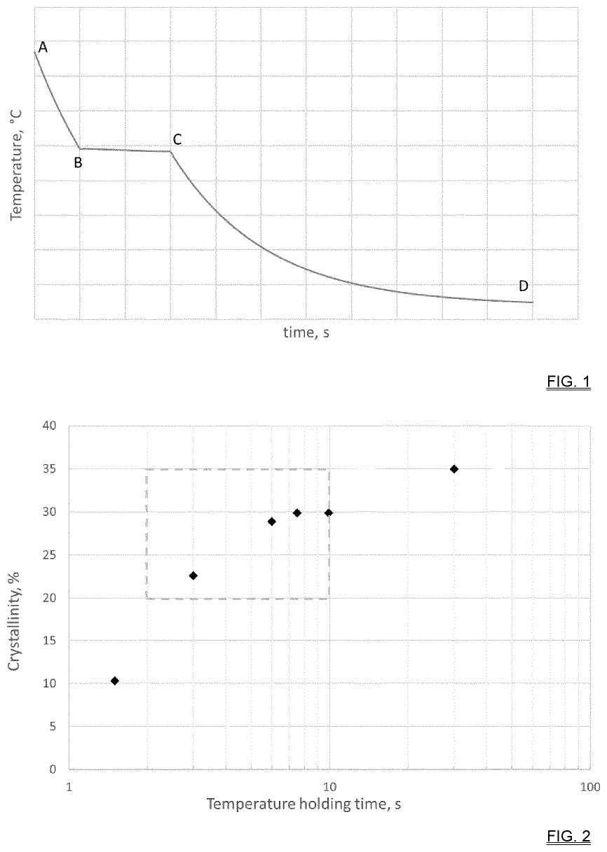

FIG. 1. Is a schematic cooling curve illustrating steps f) g) and h) of the method. On FIG. 1. The letter A indicates the temperature at which the thermoplastic polymer is applied on the heated metal element. In the present illustrative example, A=380 °C. The letter B indicates the end of step f), i.e. the target temperature after the first cooling step. In the present illustrative example, B=250 °C. The letter C indicates the end of step g), i.e. the start of the quenching step after 2 to 10s temperature holding time. The letter D indicates the end of the quenching step when the insulated metal element reaches a temperature below 50 °C.

Several samples were produced with varying stop cooling times. Additional samples with only 1s stop cooling time and with 40s stop cooling time were also produced following all other identical steps.

The percent crystallinity of the thermoplastic polymer was determined from the heats of melting and cold crystallization as measured via DSC and the reference heat of melting of the 100% crystalline thermoplastic polymer according to ASTM D3418-15. Approximately 10 mg of thermoplastic polymer was removed from the insulated metal element by e.g. scraping or grating. Heating and cooling rates of 10 °C/min were used to produce the heat flow curves. The heats of melting, ΔHm and cold crystallisation, ΔHc were determined by integrating the areas (J/g) under the peaks. The percent crystallinity was determined using the following equation:

% Crystallinity=100*[ΔHm−ΔHc]/ΔHm°

where ΔHm° is the heat of melting of a fully crystalline polymer, which is 130 J/g for PEEK.

FIG. 2 is a plot of crystallinity as a function of the stop cooling time. A too short temperature holding time between the first cooling step and the quenching step leads to low crystallinity or a completely amorphous polymer coating, causing bad adhesion between the polymer and the metal element, and unstable electrical properties. Very long stop cooling times lead to the highest crystallinity value. However, too long stop cooling time may cause variations of the coating thickness and unstable electrical properties.

An optimum was found by controlling the stop cooling time between 2 and 10 s.

3 insulated metal elements were produced according to the disclosed method and compared to 2 insulated metal elements from prior art.

Two reference samples from prior art, namely REF. 1 and REF. 2 were selected. In both samples the metal element consisted of copper with 99.9% purity and containing less than 400 ppm O₂.

In both samples the metal element had a rectangular shape with 3.7 mm width and 2 mm height, and corner radius>0.3 mm.

REF. 1 was coated with a 103 μm thick enamel layer consisting of PAI, obtained by several deposition and curing cycles.

REF. 2 was coated with a first enamel layer consisting of PAI, with a thickness of 38 μm, and a second polymer layer consisting of PEEK, with a thickness of 112 μm. The total insulation layer thickness was 150 μm.

Samples INV.1 to INV.3 were obtained with the same starting metal element, i.e. rectangular shaped copper with section dimensions 3.7 mm×2 mm and >0.3 mm corner radius.

The 3 samples produced according to the disclosed method had a PEEK coating thickness ranging between 40 μm and 300 μm.

To test adhesion, a strip of 10 mm coating section from the metal element substrate was pulled through a calibrated opening and the stripping force was measured. Stripping forces above 40 N/mm were measured in all samples.

Additionally, adhesion was tested according to IEC60317 standards, by means of elongation tests with incision through the polymer coating.

The PDIV of the different samples was measured according to the standards IEC 60664-1 and 61800 May 1.

To measure PDIV, lashed pairs of samples were made. The test voltage (AC 50 Hz, RMS) was applied at one conductor of the lashed pair, while the other was connected to earth. The test voltage was gradually increased until partial discharge was registered with the measuring capacitor above a level of 10 pC.

The table below reports the measured PDIV values for the two reference samples and the 3 invention samples.

| | | Coating | PDIV, | Crystallinity |
|---|---|---|---|---|
| SAMPLE | Coating type | thickness, μm | Vrms | % |
| REF. 1 | Enamel (PAI) | 103 | 800 | n/a |
| REF. 2 | Enamel + | 150 (38 + 112) | 1100 | n/a |
| | PEEK | | | |
| INV. 1 | PEEK | 62 | 864 | 31.9 |
| INV. 2 | PEEK | 113 | 1184 | 29.9 |
| INV. 3 | PEEK | 148 | 1485 | 30.2 |

The measured PDIV values are in good agreement with the DAKIN formula V=163 (t/εᵣ)^{0.46}

The coating thickness, t, indicated in the table needs to be doubled in the formula as pairs of samples are tested. The relative permittivity, Er, is depending on the type of coating and was estimated to be 3.9 for Enamel (PAI), and 3.1 for PEEK

High PDIV values, above 800V were obtained in all invention samples.

The metal element having a polymer coating of the present invention, associated with a more cost-effective production process, is particularly suitable for use in hairpin wire for rotating or static parts of an electric motor.

1. Method to produce an insulated metal element having stable electrical properties, comprising the steps:
a) Providing a metal element
b) Providing a thermoplastic polymer
c) Cleaning the surface of said metal element
d) Heating said metal element at a temperature between Tm+20 °C and Tm+60 °C, Tm being the melting temperature of said thermoplastic polymer
e) Applying said thermoplastic polymer on the surface of said metal element
f) Cooling the coated metal element to a temperature higher than [(Tm+Tg)/2−40 °C] and lower than [(Tm+Tg)/2+40 °C], with Tm the melting temperature of said thermoplastic polymer and Tg the glass transition temperature of said thermoplastic polymer
g) Stopping the cooling for 2s to less than 10s
h) Quenching the coated metal element to a temperature below 50 °C.

2. Method as in claim 1 wherein no reheating of the metal element occurs after the first cooling step f).

3. Method as in claim 1 wherein cooling step f) and quenching step h) occur in water.

4. Method as in claim 1 wherein hot air is used to stop the cooling at a temperature higher than [(Tm+Tg)/2−40 °C] and lower than [(Tm+Tg)/2+40 °C], with Tm the melting temperature of said thermoplastic polymer and Tg the glass transition temperature of said thermoplastic polymer.

5. Method as in claim 1 wherein steps c) to h) are executed in a production line wherewith said metal element is running at a linear velocity higher than 40m/min.

6. Insulated metal element having stable electrical properties obtained with the method of claim 1 comprising a metal element and a thermoplastic polymer coating, said thermoplastic polymer coating is in semi crystalline state, the rate of crystallinity is between 10% and 40%.

7. Insulated metal element having stable electrical properties as in claim 6 wherein the partial discharge inception voltage (PDIV) at 20 °C is higher than 800 Vrms.

8. Insulated metal element having stable electrical properties as in claim 6 wherein the metal element has a rectangular or square-shaped cross section.

9. Insulated metal element having stable electrical properties as in claim 6 wherein the metal element is a wire, rod or tube made of copper.

10. Insulated metal element having stable electrical properties as in claim 6 wherein the metal element is a wire, rod or tube made of aluminium or aluminium-alloy.

11. Insulated metal element having stable electrical properties as in claim 6 wherein the metal element is a wire, rod or tube made of steel.

12. Insulated metal element having stable electrical properties as in claim 6 wherein the thermoplastic polymer coating comprises or consists of a thermoplastic polymer from the family of PAEK.

13. Insulated metal element having stable electrical properties as in claim 6 wherein the thermoplastic polymer coating thickness is ranging from 60 μm to 500 μm.

14. Use of an insulated metal element having stable electrical properties as in claim 6 as hairpin wire for rotating or static parts of an electric motor.
